(19) United States
(12) Patent Application Publication
(10) Pub. No.: US 2013/0146695 A1
(43) Pub. Date: Jun. 13, 2013

(54) JOURNAL BRUSH SEAL ASSEMBLIES

(71) Applicant: Babcock Power Services, Inc., Worcester, MA (US)

(72) Inventors: Donald G. Maurer, Simpsonville, SC (US); Guillermo A. Vedani, Easley, SC (US)

(73) Assignee: Babcock Power Services, Inc., Worcester, MA (US)

(21) Appl. No.: 13/705,661

(22) Filed: Dec. 5, 2012

Related U.S. Application Data
(60) Provisional application No. 61/568,436, filed on Dec. 8, 2011.

(51) Int. Cl. F16J 15/44; B02C 15/00

(52) U.S. Cl. CPC F16J 15/44; B02C 15/00
USPC 241/285.1; 29/426.2; 277/355

(57) ABSTRACT

A brush seal assembly for sealing a journal assembly includes a base flange configured and adapted to be mounted to a journal head, e.g., in a vertical pulverizer. A cylindrical skirt is mounted to the base flange and extends in an axial direction from the base flange. A seal mounting ring is mounted to the skirt opposite the base flange, and an annular brush seal is mounted to the seal mounting ring. The brush seal is configured and adapted to seal between the skirt and a journal housing.

### CROSS-REFERENCE TO RELATED APPLICATIONS

This application claims priority to U.S. 61/568,436 filed Dec. 8, 2011 which is incorporated by reference herein in its entirety.

### BACKGROUND OF THE INVENTION

1. Field of the Invention

The present invention relates to journal assemblies, such as in pulverizers, and more particularly to seals for protecting journal bearings.

2. Description of Related Art

A variety of devices and methods are known in the art for reducing particulate size of raw materials. Of such devices, many are directed to pulverizing coal for use as a fuel. In coal-fired furnaces, for purposes of improved and more efficient ignition, it is preferred to pulverize the coal to a fine powder before introducing it into the furnace for combustion.

In operations that use coal for fuel, finely-ground coal particles or “fines” are desirable for efficient operation, yielding higher combustion efficiency than stoker firing, as well as rapid response to load changes. Using coal fines for combustion also produces less nitrous oxide (NO_{X}) emissions and keeps oversized loss-on-ignition (LOI) unburned coal particles from contaminating the marketable ash byproduct of the combustion chamber. Thus, it is common practice to supply raw coal to a device, such as a pulverizer, that will reduce the size of the coal to particles within a desirable range prior to being used for combustion.

Coal pulverization involves systematically comminuting coal to a desired size, e.g., a fine powder, prior to introduction into a coal-fired furnace. Conventional coal pulverization systems include ball tube type mills, high-speed attrition type pulverizers, and vertical roller type mills.

Traditional bowl mill pulverizers are shown and described in U.S. Pat. No. 3,465,971 to Dalenberg, et al., and U.S. Pat. No. 4,002,299 to Skalka, which describe the construction and operation bowl mills suitable for use in coal fired power generation systems. As taught by the patents above, a typical bowl mill includes a body portion in which a grinding table is mounted for rotation, a plurality of grinding rollers that roll against the grinding table to grind coal therebetween, coal supply means for feeding raw coal to the interior of the bowl mill, and air supply means for supplying an air flow to the interior of the bowl mill, which entrains airborne pulverized coal particles for combustion.

In such a bowl mill, the coal enters the bowl mill and is pulverized between the grinding rollers and the grinding table. After being pulverized, the coal particles are thrown outwardly by centrifugal force whereby the particles are fed into a stream of air that is entering the bowl mill. The stream of air, which now contains pulverized coal particles, flows through a tortuous path that is established in part by the positioning of a suitably supported deflector means within the bowl mill. As the stream of air and coal particles flows along the aforementioned tortuous path, the sharp turns effect the separation of the coarse coal particles from the air stream. These coarse coal particles are then returned to the grinding table for further pulverization, while the fine coal particles are carried out of the bowl mill in the air stream. The capacity of each bowl mill of the type described above can be on the order of 100 tons per hour of coal. As the industry has pressed for greater and greater capacity, the size of typical bowl mills has increased in an effort to meet the demand.

With increased size have come issues related to stress and wear. More specifically, prolonged operation of conventional bowl mills can only last as long as the service life of the weakest components. The pulverizer journal systems typically employed in conventional bowl mills have suffered from coal infiltrating the bearings in the journal assembly and causing damage to said bearings that reduce their operational life.

The result of this phenomenon is that the bearings often require replacement earlier than the other major components of a typical journal assembly. In order to replace the journal bearings, downtime is required. Thus it is often the case that downtime is incurred due to the bearings per se. The more frequently the need arises to replace the journal bearings, the more the resulting downtime adds up in the long run. Thus, there is a significant need for improvements in the service life of bearing support for journals on which pulverizer rolls are mounted.

Due to this phenomenon, there is still a need in the art for journal assemblies that allow for improved sealing and protection of bearings in order to prevent unwanted media from infiltrating the journal assembly and damaging the internal components. There also remains a need in the art for such journal assemblies that are easy to make and use. The present invention provides a solution for these problems.

### SUMMARY OF THE INVENTION

The subject invention is directed to a new and useful brush seal assembly for sealing a journal assembly. The brush seal assembly includes a base flange configured and adapted to be mounted to a journal head, e.g., in a vertical pulverizer. A cylindrical skirt is mounted to the base flange and extends in an axial direction from the base flange. A seal mounting ring is mounted to the skirt opposite the base flange, and an annular brush seal is mounted to the seal mounting ring. The brush seal is configured and adapted to seal between the skirt and a journal housing.

In certain embodiments, the seal mounting ring is a first clamping ring, and the brush seal is removably mounted between the first clamping ring and a second clamping ring. The first clamping ring can be mounted to an inward surface of the skirt. The second clamping ring can be removably mounted, e.g., bolted, to the skirt for clamping the brush seal between the first and second clamping rings.

In accordance with certain embodiments, the base flange includes an annular flange ring welded to an outside surface of a cylindrical flange skirt. The base flange and first clamping ring can be welded to the skirt, i.e., fabricated, however it is also contemplated that the base flange and first clamping ring can be formed integrally with the skirt.

The invention also provides a journal assembly. The journal assembly includes a journal shaft mounted to a journal head and defining a longitudinal axis. The journal head is configured and adapted to be mounted in a pulverizer. The journal assembly also includes a journal housing mounted for rotational movement relative to the journal shaft. A brush seal assembly as described above is included, wherein the base flange is mounted to the journal head, and wherein the brush seal seals between the skirt and the journal housing.

In certain embodiments, the journal housing includes an upper journal housing mounted for rotational movement relative to the journal shaft, and a lower journal housing mounted for rotational movement relative to the journal shaft. The lower journal housing is mounted to the upper journal housing for common rotation about the journal shaft. The brush seal can seal between the skirt and the upper journal housing. It is contemplated that each of the first and second clamping rings as described above can form a secondary seal with the journal housing. Bristles of the brush seal can be located axially between the first and second clamping rings.

The invention also includes a method of retrofitting a journal assembly. The method includes removing an upper journal head skirt from a journal head and replacing the upper journal head skirt by mounting a brush seal assembly as described above to the journal head. Replacing the upper journal head skirt includes forming a seal with the brush seal between the skirt and a journal housing mounted for rotational movement relative to the journal head.

In certain embodiments of the method, the seal mounting ring is a first clamping ring, and replacing the upper journal head skirt includes removably mounting the brush seal between the first clamping ring and a second clamping ring. Removably mounting the brush seal can include removably mounting, e.g., bolting, the second clamping ring to the skirt for clamping the brush seal between the first and second clamping rings.

These and other features of the systems and methods of the subject invention will become more readily apparent to those skilled in the art from the following detailed description of the preferred embodiments taken in conjunction with the drawings.

### BRIEF DESCRIPTION OF THE DRAWINGS

So that those skilled in the art to which the subject invention appertains will readily understand how to make and use the devices and methods of the subject invention without undue experimentation, preferred embodiments thereof will be described in detail herein below with reference to certain figures, wherein:

FIG. 1 is a perspective view of a prior art journal assembly, showing the journal head and skirt;

FIG. 2 is a cross-sectional perspective view of the journal assembly of FIG. 1, showing the journal shaft and the seal formed between the upper journal head skirt and the upper journal housing;

FIG. 3 is an enlarged cross-sectional perspective view of the journal assembly of FIG. 2, showing the air gap between the upper journal head skirt and the upper journal housing;

FIG. 4 is a perspective view of an exemplary embodiment of a journal assembly constructed in accordance with the present invention, showing the journal head and the skirt of the brush seal assembly;

FIG. 5 is a cross-sectional perspective view of the journal assembly of FIG. 4, showing the seal formed between the skirt of the brush seal assembly and the upper journal housing;

FIG. 6 is an enlarged cross-sectional perspective view of the journal assembly of FIG. 5, showing the brush seal clamped between the two clamping rings;

FIG. 7 is a cross-sectional elevation view of the brush seal assembly of FIG. 5, showing the clamping rings clamping the brush seal axially therebetween;

FIG. 8 is a perspective view of a portion of the brush seal assembly of FIG. 7, showing the set screws for preventing rotation of the brush seal within the assembly; and

FIG. 9 is a cross-sectional side elevation view of a portion of the brush seal assembly of FIG. 8, showing the set screw at the cross-sectional location indicated in FIG. 8.

### DETAILED DESCRIPTION OF THE PREFERRED EMBODIMENTS

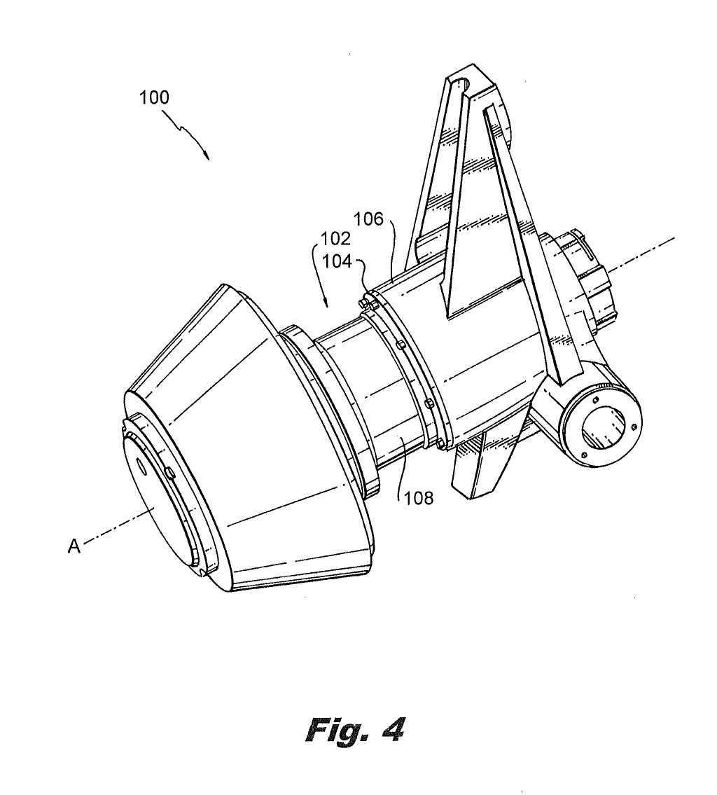

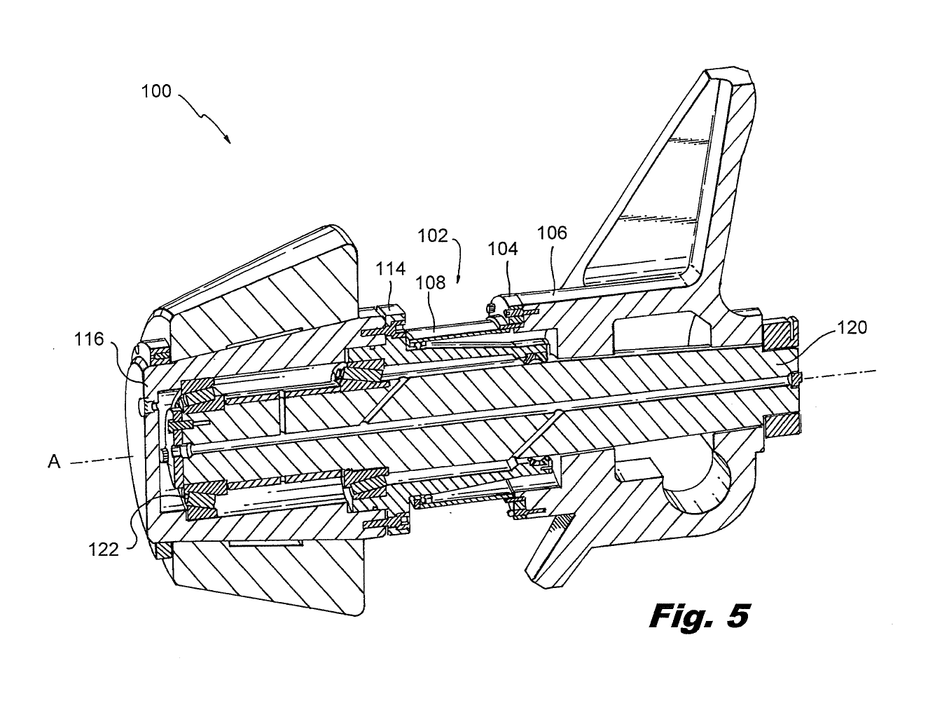

Reference will now be made to the drawings wherein like reference numerals identify similar structural features or aspects of the subject invention. For purposes of explanation and illustration, and not limitation, a partial view of an exemplary embodiment of a journal assembly in accordance with the invention is shown in FIG. 4 and is designated generally by reference character 100. Other embodiments of journal assemblies in accordance with the invention, or aspects thereof, are provided in FIGS. 5-7, as will be described. The systems and methods of the invention can be used to improve performance of journal bearing assemblies, for example in vertical mill type pulverizers, including improved sealing to protect journal bearings and extend the service life thereof.

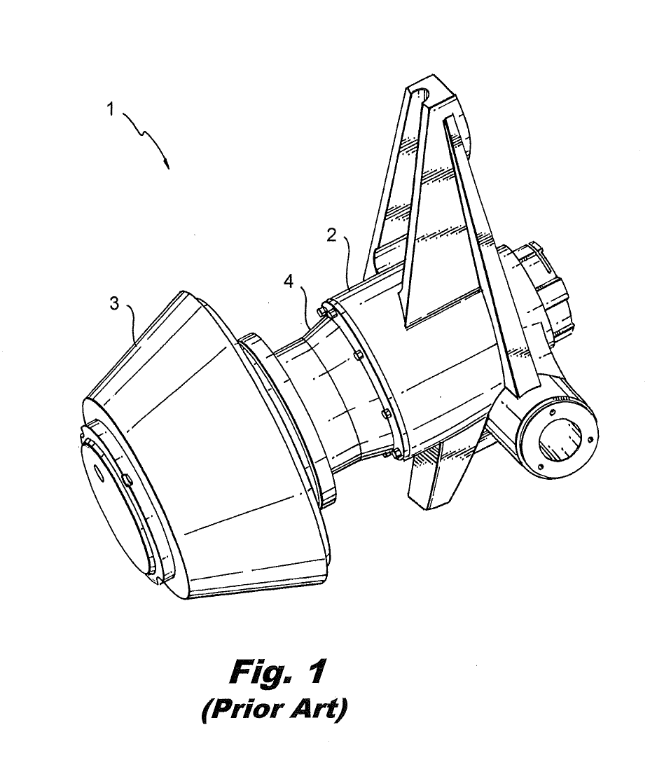

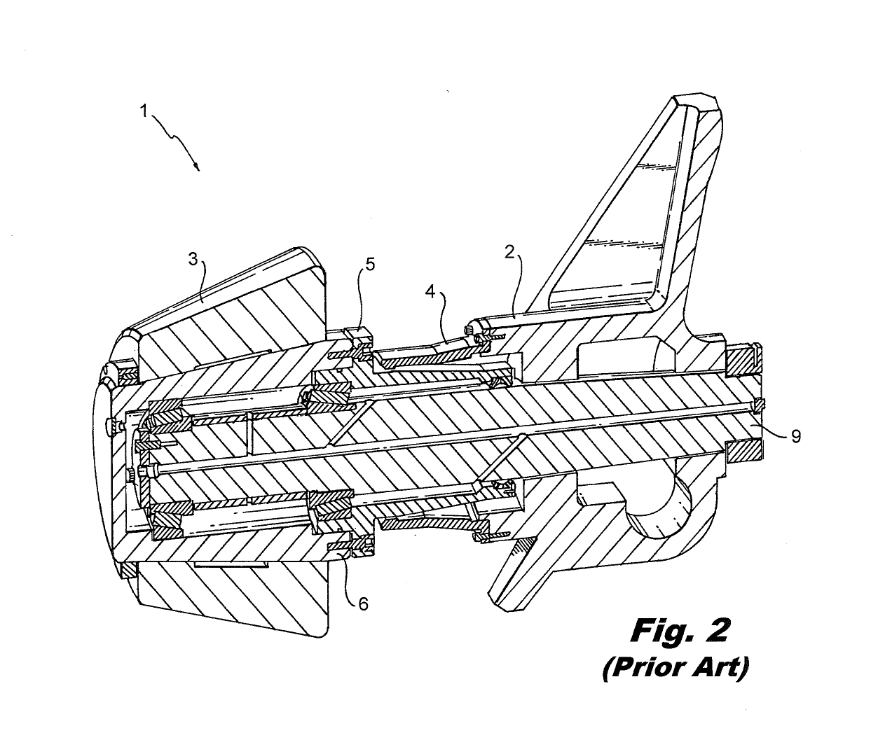

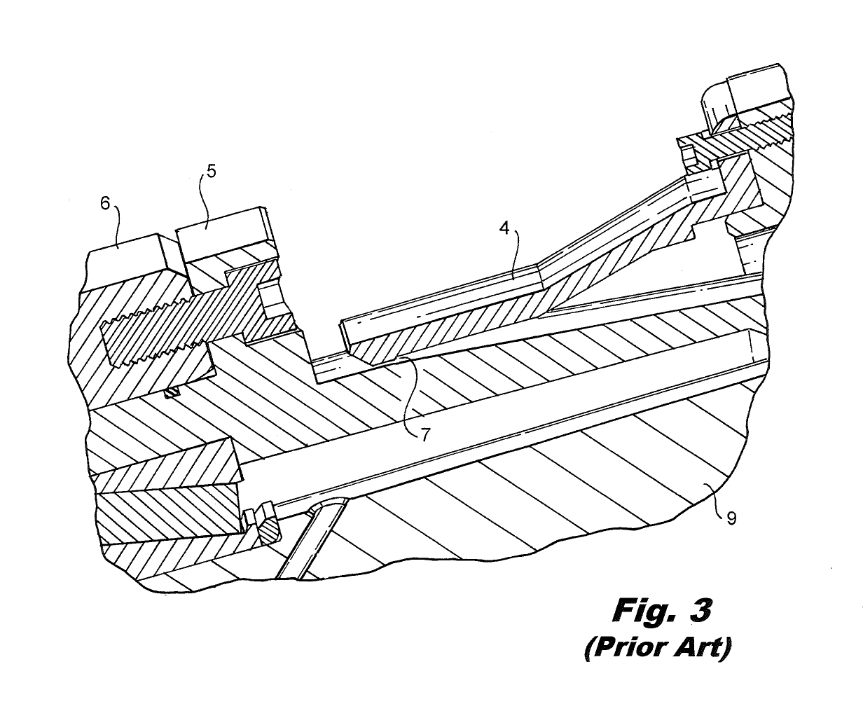

Referring first to FIG. 1, a typical journal assembly 1 includes a journal head 2 which is a stationary component mounted to a pulverizer housing, and a rotating tire 3 for crushing material to be comminuted in the pulverizer. An upper journal head skirt 4 seals between the stationary components and the rotating components to protect against pulverized materials, e.g., coal fines, fouling the bearings within the assembly. FIG. 2 shows a cross-section of this assembly, including the upper and lower journal housings 5 and 6, respectively, and journal shaft 9. The area of particular interest is the air gap 7 between upper journal head skirt 4, and the upper journal housing 5. This area can be more clearly identified in FIG. 3. Typically pressurized air is supplied through the journal housing directly into the cavity between skirt 4 and upper housing 6 by means of holes that are not shown in the figures. The pressurized air flows outward through air gap 7 to discourage pulverized fines from entering, where it causes accelerated wearing of the bearings. However, a considerable amount of pulverized fines can still enter the assembly through air gap 7, and these particles can foul the bearings inside the assembly.

Referring now to FIG. 4, the present invention can reduce or eliminate particle ingress through the air gap described above. In short, a brush seal in accordance with the invention is provided in place of the air gap. The brush seal allows for pressurized air to flow through it, but adds an additional obstacle, i.e., solid material in the form of brush bristles, that reduce and even prevent the pulverized particles such as coal fines from infiltrating from the outside of a journal assembly to the inside of the same, where they could eventually reach into the bearing cavity and the bearings themselves. The methods and apparatus in accordance with the present invention delay or even prevent bearing failure due to pulverized particles infiltrating and destroying the bearings. Journal assembly 100 includes a brush seal assembly 102.

With reference now to FIG. 5, brush seal assembly 102 includes a base flange 104 mounted to a journal head 106, which in turn can be mounted, e.g., in a vertical mill type pulverizer. A journal shaft 120 is mounted to journal head 106 and defines the longitudinal axis A. A cylindrical skirt 108 is mounted to base flange 104 and extends in an axial direction along the longitudinal axis A from base flange 106. In use, journal head 106, brush seal assembly 102, and journal shaft 120 are non-rotating components.

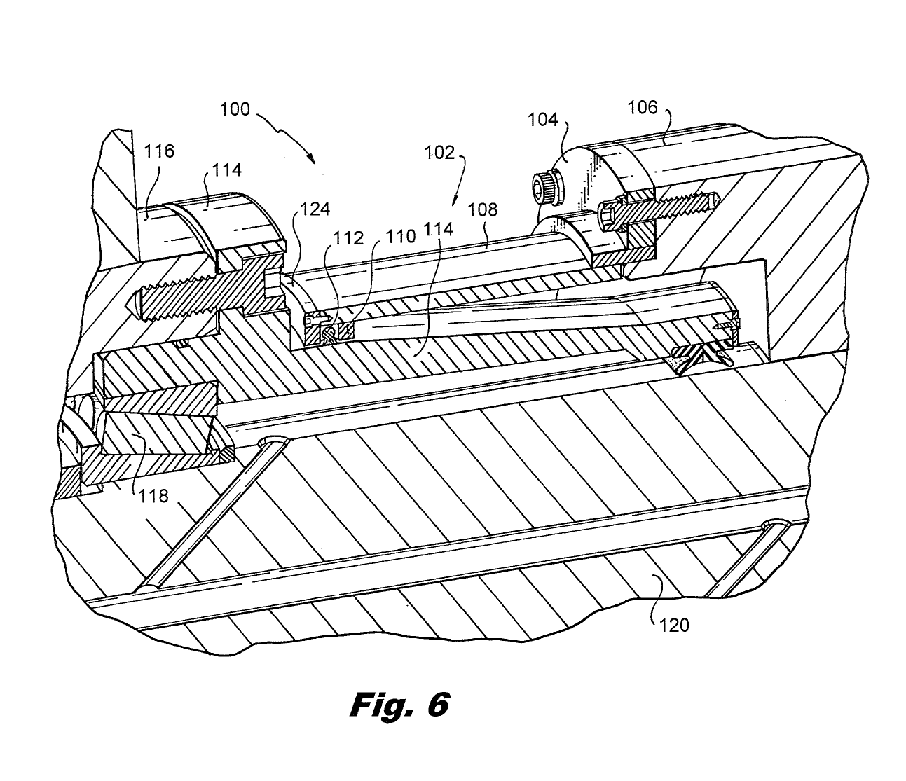

Referring now to FIG. 6, a seal mounting ring 110 is mounted to skirt 108 opposite base flange 104. An annular brush seal 112 is mounted to seal mounting ring 110, sealing between skirt 108 and a journal housing. The journal housing includes an upper journal housing 114 mounted on bearing 118 for rotational movement relative to journal shaft 120, and a lower journal housing 116 mounted on bearing 122 (shown in FIG. 5) for rotational movement relative to journal shaft 120. Upper and lower journal housings 114 and 116 are mounted together for common rotation about journal shaft 120 as a journal housing. Brush seal 112 seals between skirt 108 and upper journal housing 114.

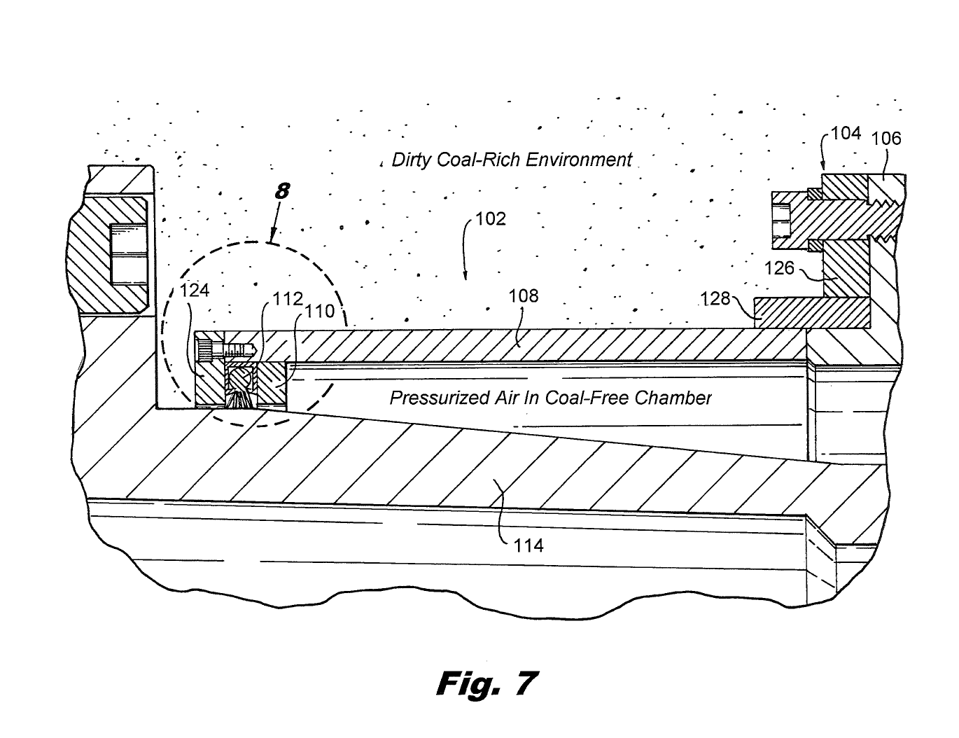

With reference now to FIG. 7, seal mounting ring 110 is the first of two clamping rings. The second is clamping ring 124. Brush seal 112 is removably mounted between rings 110 and 124. Seal mounting ring 110 is mounted to the inward facing cylindrical surface of skirt 108, e.g., by welding or any other suitable method. Second clamping ring 124 is removably mounted to the end of skirt 108, clamping brush seal 112 between the first and second clamping rings 110 and 124. While depicted as being bolted to skirt 108, those skilled in the art will readily appreciate that second clamping ring 124 can be mounted in any other suitable manner.

With continued reference to FIG. 7, base flange 104 includes an annular flange ring 126 mounted, e.g., welded, to an outside surface of a cylindrical flange skirt 128, which in turn is mounted to the outer cylindrical surface of skirt 108. Base flange 104 and seal mounting ring 110 are shown in FIG. 7 welded to skirt 108, i.e., the combined skirt 108, annular flange ring 126, flange skirt 128, and seal mounting ring 110 are fabricated, however those skilled in the art will readily appreciate that any or all of these components can be formed integrally as a single piece, e.g., by casting or the like, without departing from the spirit and scope of the invention.

Each of the first and second clamping rings 110 and 124 forms a secondary seal with the journal housing. In particular, there is a small air gap between each of the clamping rings 110 and 124 and upper journal housing 114. Bristles of the brush seal 112 are located axially between the first and second clamping rings 110 and 124. Since the bristles directly contact the outer surface of upper journal housing 114, they form a physical barrier, i.e., solid rather than gaseous, in addition to the air flowing through the adjacent air gaps. The bristles provide solid material that serves to deflect incoming particles, thereby sealing the space inside skirt 108 against incoming particles. Since the bristles are not air tight, they also allow for the pressurized air described above to pass through from inside skirt 108 through the air gaps of rings 110 and 124 for additional protection against ingress of pulverized particles.

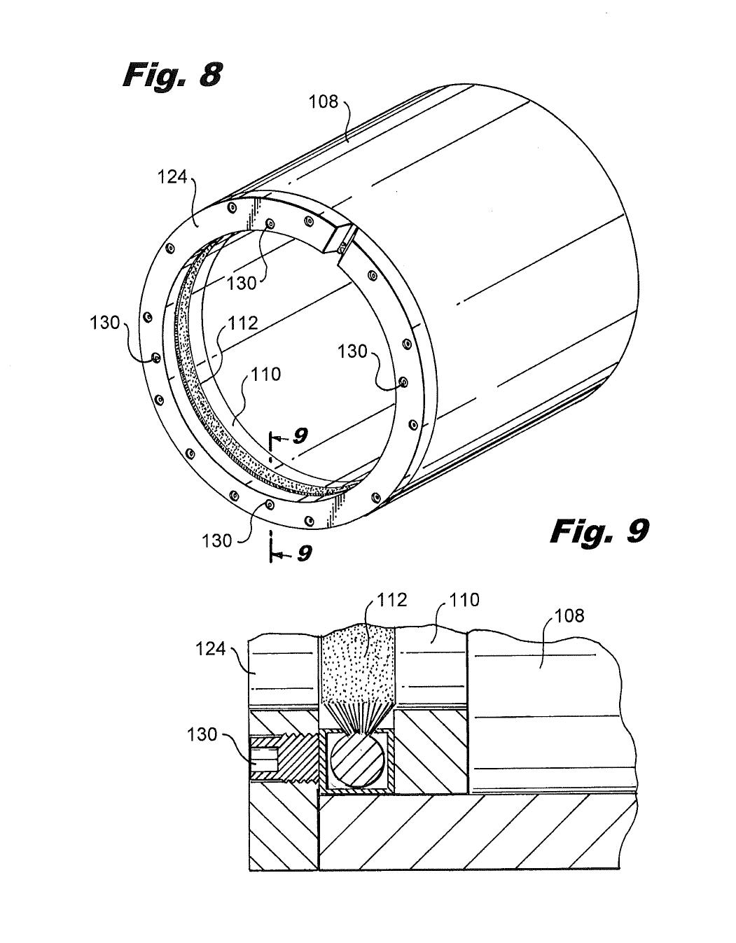

Referring now to FIG. 8, in addition to the bolts holding clamping ring 124 onto skirt 108, there are four set screws 130 passing through clamping ring 124. These set screws 130 apply pressure onto brush seal 112, and they do not pass through brush seal 112 or mounting ring 110, as shown in FIG. 9. The added pressure from set screws 130 prevents brush seal 112 from spinning in place while in operation. While shown and described using four set screws 130 as an example, any suitable number of set screws can be used without departing from the scope of the invention. For example, more set screws may be needed for larger sizes of brush seals and vice versa. Any suitable number of set screws can be used depending on the size of the mill, diameter of the skirt, performance, and the like.

Those skilled in the art will readily appreciate that any suitable materials can be used without departing from the scope of the invention. For example, the bristles of the brush seal 112 can be made of 304 stainless steel or any other suitable material. As another example, the brush seal assembly components can be made of AR 400 or any other suitable material.

The invention also includes a method of retrofitting a journal assembly. For example, the method can be used to convert a traditional journal assembly as in FIGS. 1-3 to have a brush seal assembly as shown in FIGS. 4-7. The method includes removing an upper journal head skirt (e.g., skirt 4 in FIG. 1) from a journal head (e.g., journal head 2 in FIG. 1) and replacing the upper journal head skirt by mounting a brush seal assembly (e.g., brush seal assembly 102 in FIG. 7) to the journal head. Replacing the upper journal head skirt includes forming a seal with the brush seal (e.g., brush seal 112 in FIG. 7) between the skirt and a journal housing (e.g., upper journal housing 114 in FIG. 7) mounted for rotational movement relative to the journal head. Replacing the upper journal head skirt can optionally include removably mounting the brush seal between the first clamping ring (e.g., seal mounting ring 110 in FIG. 7) and a second clamping ring (e.g., second clamping ring 124 in FIG. 7). For example, this can include bolting the second clamping ring to the skirt.

The exemplary embodiments described above include a single continuous skirt that surrounds the journal housing through a full 360° circumferentially. However, those skilled in the art will readily appreciate that this is exemplary only, and that any other suitable configuration can be used. For example, the skirt can be designed and manufactured in two (or more) pieces that each surround the journal housing through 180° or less, which pieces could be assembled into place without the need to remove the journal head.

While shown and described above in the exemplary context of joining methods such as welding and bolting, those skilled in the art will readily appreciate that any other suitable joining techniques can be used. Additionally, while casting has been provided as an example for forming integral pieces, those skilled in the art will readily appreciate that any other suitable forming techniques can be used without departing from the scope of the invention.

The methods and systems of the present invention, as described above and shown in the drawings, provide for journal assemblies with superior properties including improved sealing for extended life of journal bearings. While the apparatus and methods of the subject invention have been shown and described with reference to preferred embodiments, those skilled in the art will readily appreciate that changes and/or modifications may be made thereto without departing from the spirit and scope of the subject invention.

What is claimed is:

1. A brush seal assembly for sealing a journal assembly comprising:
a base flange configured and adapted to be mounted to a journal head;
a cylindrical skirt mounted to the base flange and extending in an axial direction from the base flange;
a seal mounting ring mounted to the skirt opposite the base flange; and
an annular brush seal mounted to the seal mounting ring, wherein the brush seal is configured and adapted to seal between the skirt and a journal housing.

2. A brush seal assembly as recited in claim 1, wherein the seal mounting ring is a first clamping ring, and wherein the brush seal is removably mounted between the first clamping ring and a second clamping ring.

3. A brush seal assembly as recited in claim 2, wherein the first clamping ring is mounted to an inward surface of the skirt.

4. A brush seal assembly as recited in claim 2, wherein the base flange and first clamping ring are welded to the skirt.

5. A brush seal assembly as recited in claim 2, wherein the second clamping ring is removably mounted to the skirt for clamping the brush seal between the first and second clamping rings.

6. A brush seal assembly as recited in claim 2, wherein the second clamping ring is bolted to the skirt for clamping the brush seal between the first and second clamping rings.

7. A brush seal assembly as recited in claim 1, wherein the base flange includes an annular flange ring welded to an outside surface of a cylindrical flange skirt.

8. A journal assembly comprising:
a journal shaft mounted to a journal head and defining a longitudinal axis, the journal head being configured and adapted to be mounted in a pulverizer;
a journal housing mounted for rotational movement relative to the journal shaft; and
a brush seal assembly including:
a base flange mounted to the journal head;
a cylindrical skirt mounted to the base flange and extending in an axial direction from the base flange;
a seal mounting ring mounted to the skirt opposite the base flange; and
an annular brush seal mounted to the seal mounting ring, wherein the brush seal seals between the skirt and the journal housing.

9. A journal assembly as recited in claim 8, wherein the journal housing includes:
an upper journal housing mounted for rotational movement relative to the journal shaft; and
a lower journal housing mounted for rotational movement relative to the journal shaft, the lower journal housing being mounted to the upper journal housing for common rotation about the journal shaft, wherein the brush seal seals between the skirt and the upper journal housing.

10. A journal assembly as recited in claim 8, wherein the seal mounting ring is a first clamping ring, and wherein the brush seal is removably mounted between the first clamping ring and a second clamping ring.

11. A journal assembly as recited in claim 10, wherein the first clamping ring is mounted to an inward surface of the skirt.

12. A journal assembly as recited in claim 10, wherein the base flange and first clamping ring are welded to the skirt.

13. A journal assembly as recited in claim 10, wherein the second clamping ring is removably mounted to the skirt for clamping the brush seal between the first and second clamping rings.

14. A journal assembly as recited in claim 10, wherein the second clamping ring is bolted to the skirt for clamping the brush seal between the first and second clamping rings.

15. A journal assembly as recited in claim 10, wherein each of the first and second clamping rings forms a secondary seal with the journal housing, and wherein bristles of the brush seal are located axially between the first and second clamping rings.

16. A journal assembly as recited in claim 8, wherein the base flange includes an annular flange ring welded to an outside surface of a cylindrical flange skirt.

17. A method of retrofitting a journal assembly comprising:
removing an upper journal head skirt from a journal head;
replacing the upper journal head skirt by mounting a brush seal assembly to the journal head, wherein the brush seal assembly includes:
a base flange for mounting the brush seal assembly to the journal head;
a cylindrical skirt mounted to the base flange and extending in an axial direction from the base flange;
a seal mounting ring mounted to the skirt opposite the base flange; and
an annular brush seal mounted to the seal mounting ring, wherein replacing the upper journal head skirt includes forming a seal with the brush seal between the skirt and a journal housing mounted for rotational movement relative to the journal head.

18. A method as recited in claim 17, wherein the seal mounting ring is a first clamping ring, wherein replacing the upper journal head skirt includes removably mounting the brush seal between the first clamping ring and a second clamping ring.

19. A method as recited in claim 18, wherein removably mounting the brush seal includes removably mounting the second clamping ring to the skirt for clamping the brush seal between the first and second clamping rings.

20. A method as recited in claim 19, wherein mounting the second clamping ring includes bolting the second clamping ring to the skirt for clamping the brush seal between the first and second clamping rings.
